(19) United States
(12) Patent Application Publication
(10) Pub. No.: US 2019/0165492 A1
(43) Pub. Date: May 30, 2019

(54) TERMINAL CONNECTING METHOD AND TERMINAL

(71) Applicant: YAZAKI CORPORATION, Tokyo (JP)

(72) Inventors: Shinya WARASHINA, Makinohara-shi (JP); Tomohiro KAKO, Makinohara-shi (JP)

(73) Assignee: YAZAKI CORPORATION, Tokyo (JP)

(21) Appl. No.: 16/184,508

(22) Filed: Nov. 8, 2018

(30) Foreign Application Priority Data
Nov. 30, 2017 (JP) 2017-230913

(51) Int. Cl. H01R 4/18; H01R 43/048; H01R 43/02

(52) U.S. Cl. CPC H01R 4/187; H01R 4/185; H01R 43/0263; H01R 43/0249; H01R 43/0207; H01R 43/0484

(57) ABSTRACT

A terminal connecting method includes setting a conductor having a plurality of strands on an upper surface of a bottom portion of an electric wire crimping part of a terminal, caulking the conductor in a manner to cover the conductor, and thereby crimping the conductor by a caulking portion and a connecting caulking portion extended from the bottom portion, and rotating and pressing a friction stir tool into a stir welding area in a part in which the conductor is crimped by the connecting caulking portion, and performing friction stir welding, after caulking and crimping.

### CROSS REFERENCE TO RELATED APPLICATIONS

This application claims priority from Japanese Patent Application No. 2017-230913 filed on Nov. 30, 2017, the entire contents of which are incorporated herein by reference

### BACKGROUND OF THE INVENTION

### Field of the Invention

The invention relates to a terminal connecting method for connecting a terminal to an electric wire and a terminal to which an electric wire is connected.

### Description of Related Art

In a conventional terminal connecting structure for connecting a terminal to an electric wire, generally, a pair of caulking portions formed in an electric wire crimping part of the terminal are caulked to a conductor exposed to the end portion of an electric wire with an insulating coating peeled off therefrom, whereby the terminal is connected to the electric wire.

Incidentally, recently, there is a movement in which, as an electric wire used in an automotive wire harness, an aluminum electric wire is used instead of a copper electric wire from lightness and good recyclability. However, when the aluminum electric wire is used as the electric wire of the automotive wire harness, a strong oxide film having large electrical resistance exists on the surface of an aluminum- or aluminum alloy-made conductor, which lowers the electrical contact performance in connecting the terminal to the electric wire.

In view of the above problem, for example, in a method for manufacturing an electric wire with terminal fittings disclosed in the patent document 1, a core wire of an electric wire is sandwiched by a jig and ultrasonic vibrations are applied to the core wire to form roughened areas in the surfaces of a plurality of strands, and, after then, a crimping part of a terminal is crimped to the roughened areas. Then, the roughened areas formed on the surfaces of the strands rub against each other to peel off films such as oxide films formed on the surfaces of the strands. Thus, the strands, whose newly generated surfaces are exposed, come into contact with each other and thus they are electrically connected to each other, thereby reducing the electrical resistance between the electric wire and terminal.

Also, for example, in a terminal connecting structure disclosed in the patent documents 2 and 3, a connecting tool capable of frictionally welding a caulking part of a terminal is bitten into the caulking part to thereby form a friction stir welding portion. According to this terminal connecting structure, an electric wire crimping part is fixed by a connecting force due to the friction stir welding, whereby the electrical contact resistance between the terminal and electric wire can be reduced.

### [Patent Document 1] JP-A-2011-82127

### [Patent Document 2] JP-A-2009-187683

### [Patent Document 3] JP-A-2012-28112

### SUMMARY OF THE INVENTION

### Problems that the Invention is to Solve

According to a related art, in an electric wire with terminal fittings manufacturing method, ultrasonic equipment for applying ultrasonic vibrations to the core wire of the electric wire is often expensive, resulting in the increased manufacturing cost.

According to a related art, in a terminal connecting structure, a pin portion of the rotating connecting tool is bitten into the electric wire crimping part, and the thus-bitten portion of the electric wire crimping part and a conductor are caused to flow plastically. Therefore, the pin portion bitten can apply stress to the caulking portion in the opening direction thereof, or can break the core wire of the conductor. This can lower the fixing force of the electric wire crimping part to the conductor.

### SUMMARY

One or more embodiments provide an inexpensive terminal connecting method which can reduce the electrical contact resistance with a conductor without lowering the fixing force of an electric wire crimping part to the conductor.

In an aspect (1), a terminal connecting method includes setting a conductor having a plurality of strands on an upper surface of a bottom portion of an electric wire crimping part of a terminal, caulking the conductor in a manner to cover the same, and thereby crimping the conductor by a caulking portion and a connecting caulking portion extended from the bottom portion, and rotating and pressing a friction stir tool into astir welding area in apart in which the conductor is crimped by the connecting caulking portion, and performing friction stir welding, after caulking and crimping.

According to the aspect (1), in the stir welding area of the terminal, using the friction stir tool, a portion of the terminal and the plurality of strands are allowed to flow plastically and thus they are frictionally stirred and connected to each other. In this case, the strands of the conductor are connected together due to breakage of films such as oxide films formed on the surfaces thereof and thus they are integrated with the terminal, thereby enhancing the electrical connection reliability. Also, since the friction stir connection is performed in the stir welding area that is a crimping portion formed by the connecting caulking portion different from the conductor caulking portions, the fixing force of the conductor caulking portions to the conductor cannot be lowered. In other words, since the conductor is mechanically connected in the conductor caulking portions and the conductor is mechanically and electrically connected in the stir welding area, the conductor can be connected to the terminal stably. That is, when frictionally welding and connecting together a portion of the terminal and the plurality of strands in the stir welding area, an adverse effect on the conductor caulking portions can be eliminated. Thus, the electrical contact resistance can be lowered without reducing the fixing force of the terminal to the conductor.

Also, since a portion of the terminal and the plurality of strands in the stir welding area can be frictionally stirred connected together using a friction stir tool having a simple configuration capable of rotation, expensive ultrasonic equipment is not required and thus the manufacturing cost can be reduced.

In an aspect (2), in the performing friction stir welding, a moving stir operation in which the friction stir tool is moved along the bottom portion is performed, after rotating and pressing the friction stir tool into the stir welding area.

According to the aspect (2), since the conductor is frictionally stirred in a wide range in the stir welding area, the electrical connection reliability can be further enhanced.

In an aspect (3), in the performing friction stir welding, the terminal is fitted into and held by a holding recessed portion formed in a jig.

According to the aspect (3), when the stir welding area is frictionally stirred by the friction stir tool, since the terminal is held in the holding recessed portion, the friction stir operation can be executed stably and smoothly. Also, the deformation of the terminal and the opening of the connecting caulking portion due to execution of the friction stir operation can be suppressed.

In an aspect (4), the conductor is a bundle of the plurality of strands exposed in one end portions of a plurality of electric wires in which insulating coating are peeled off respectively.

According to the aspect (4), by frictionally welding the strands in the bundle of the core wires respectively exposed to the end portions of the plurality of electric wires and a portion of the terminal, the plurality of electric wires can be connected to the terminal stably and easily.

In an aspect (5), the plurality of strands are made of aluminum or aluminum alloy.

According to the aspect (5), the present method is particularly effective when crimping an aluminum electric wire and a terminal to each other. That is, in the case of the aluminum electric wire, strong oxide films exist on the surfaces of the strands made of aluminum or aluminum alloy, which provides an inhibitory factor in reducing the electrical resistance. However, since the oxide films formed on the surfaces of the plurality of strands are broken by the frictionally welding operation, the terminal and aluminum electric wire can be connected together with small electrical connection resistance.

In an aspect (6), a terminal includes a bottom portion on which a conductor having a plurality of strands is set, and a conductor caulking portion and a connecting caulking portion extended from the bottom portion and respectively caulked in a manner to cover the conductor so as to crimp the conductor. The conductor caulking portion in which the conductor is crimped, includes a stir welding area into which a friction stir tool is rotated and pressed and in which friction stir welding is performed.

According to the aspect (6), after it is crimped to the conductor, in the stir welding area, a portion of the terminal and the plurality of strands are allowed to flow plastically and thus they are frictionally stirred and connected to each other by the friction stir tool. In this case, films such as oxide films formed on the surfaces of the strands of the conductor are broken by the friction stir operation, and thus the strands are allowed to be connected together; and, the thus-connected strands are integrated with the terminal, resulting in the enhanced electrical connection reliability. Also, since the terminal and conductor are frictionally stirred and connected to each other in the stir welding area that is a crimping portion formed by the connecting caulking portion different from the conductor caulking portions, the fixing force of the conductor caulking portions to the conductor cannot be lowered. In other words, since the conductor is mechanically connected in the conductor caulking portions and the conductor is mechanically and electrically connected in the stir welding area, the conductor is connected to the terminal stably. That is, when a portion of the terminal and the plurality of strands are frictionally stirred and connected together in the stir welding area, an adverse effect on the conductor caulking portions is eliminated. Thus, the electrical contact resistance can be reduced without lowering the fixing force of the terminal to the conductor.

According to one or more embodiments, it is possible to provide an inexpensive terminal connecting method and a terminal which can reduce the electrical contact resistance with a conductor without lowering the fixing force to the conductor.

The invention has been described briefly hereinabove. Further, when the below-described mode for carrying out the invention (which is hereinafter called “embodiments”.) is read through with reference to the accompanying drawings, the details of the invention will be further clarified.

### BRIEF DESCRIPTION OF THE DRAWINGS

FIGS. 1A to 1C are perspective views for explaining the steps of a terminal connecting method and a terminal according to a first embodiment.

FIGS. 2A and 2B are plan views for explaining the terminal connecting method shown in FIGS. 1A to 1C.

FIGS. 3A to 3C are section views for explaining the terminal connecting method shown in FIGS. 1A to 1C.

FIGS. 4A and 4B are plan views for explaining a moving stir operation to be executed in a frictionally welding step.

FIGS. 5A and 5B are plan views for explaining the moving stir operation in the frictionally welding step.

FIGS. 6A and 6B are section views for explaining a frictionally welding step using a jig.

FIGS. 7A and 7B are section views for explaining another example of the frictionally welding step.

FIGS. 8A to 8C are perspective views for explaining the steps of a terminal connecting method and a terminal according to a second embodiment.

### DETAILED DESCRIPTION

Description is given below of embodiments according to the invention.

### First Embodiment

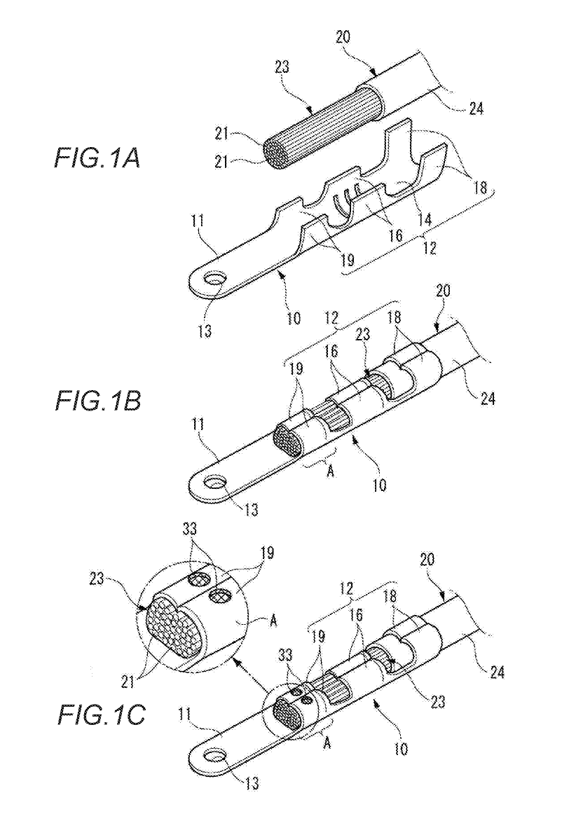

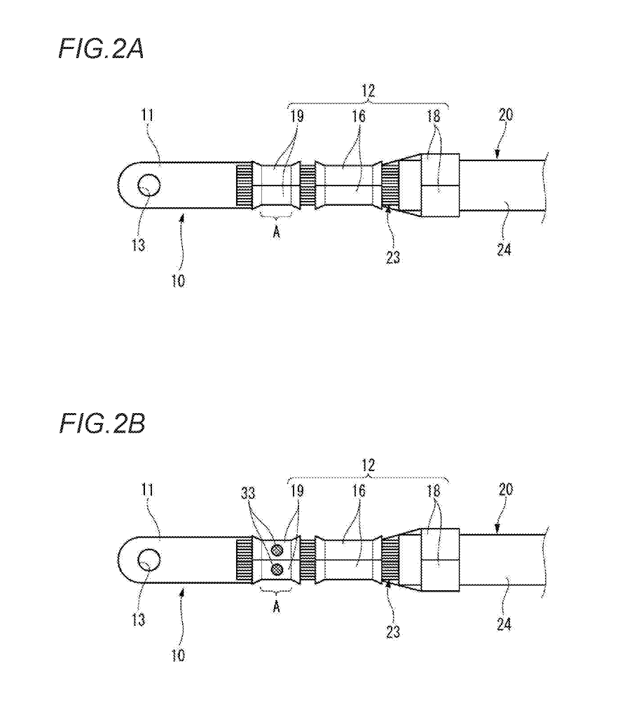

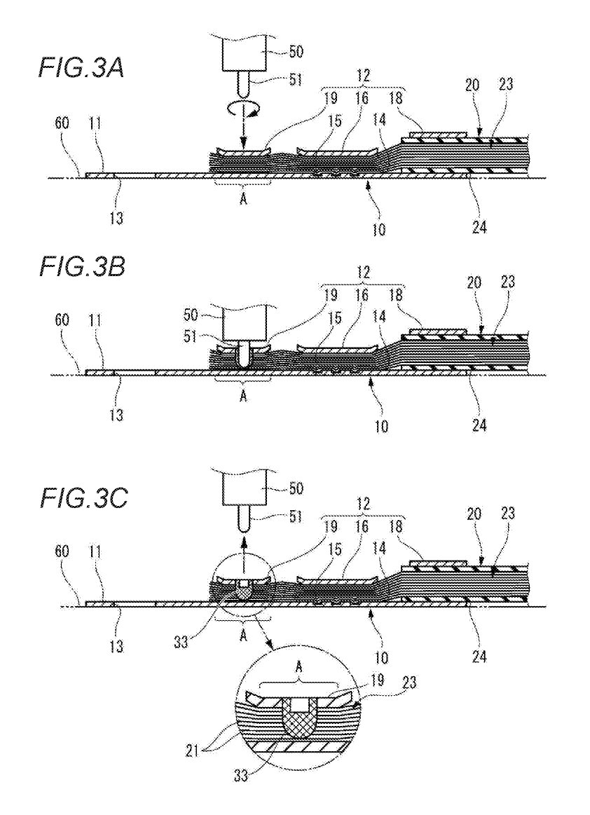

FIGS. 1A to 1C are perspective views for explaining the steps of a terminal connecting method according to a first embodiment of the invention. FIGS. 2A and 2B are plan views for explaining the terminal connecting method shown in FIGS. 1A to 1C, and FIGS. 3A to 3C are section views for explaining the terminal connecting method shown in FIGS. 1A to 1C.

As shown in FIGS. 1A to 1C, 2A and 2B, and 3A to 3C, the first embodiment of the invention provides a terminal connecting method for connecting a terminal 10 to an electric wire 20, and the terminal 10 to which the electric wire 20 is connected. Here, in this specification, the terminal connecting method for connecting the terminal 10 and electric wire 20 is described assuming that the terminal 10 side is [the front side] and the electric wire 20 side is [the rear side].

The electric wire 20, as shown in FIG. 1A, is an aluminum electric wire whose conductor 23 is made of aluminum or aluminum alloy. The conductor 23 is formed by bundling together the plurality of strands 21. An insulating coating 24 is made of electrically insulating synthetic resin and is formed to surround the outer periphery of the conductor 23 to thereby protect the conductor 23 from being insulatable from outside. In the end portion of the electric wire 20, the insulating coating 24 is peeled off therefrom to expose the conductor 23. A conductor caulking portion 16 and a connecting caulking portion 19 of the terminal 10 are connected to the thus exposed conductor 23. An area where the conductor 23 is caulked by the connecting caulking portion 19 is referred to as [a stir welding area A]. This stir welding area A includes friction stir connection portions 33 formed by allowing the conductor 23 and the connecting caulking portion 19 to plastically flow integrally. Here, in the terminal connecting method of the present embodiment, the electric wire is not limited to the aluminum electric wire but various electric wires such as a copper electric wire made of copper or copper alloy can also be used.

The terminal 10 is a terminal which, as shown in FIG. 1A, is formed by molding a plate-shaped member made of metal such as copper or copper alloy by mold press working or the like. The terminal 10 includes a partner connecting part 11 and an electric wire crimping part 12 formed integrally with the partner connecting part 11.

The electric wire crimping part 12 includes a bottom portion 14, a pair of conductor caulking portions 16 respectively extended from both side edges of the bottom portion 14, a pair of coating caulking portions 18 formed continuously with the rear of the conductor caulking portions 16, and a connecting caulking portion 19 formed continuously with the front of the conductor caulking portions 16. The electric wire crimping part 12 includes an area where the connecting caulking portion 19 is formed, which is referred to as a stir welding area A. Here, the terminal connecting method of the present embodiment may be a terminal connecting method for connecting a terminal, whose electric wire crimping part 12 excludes the coating caulking portions 18 but includes only the conductor caulking portions 16 and connecting caulking portions 19, to an electric wire.

Also, serrations (recessed portions) 15 are formed in the inner surfaces of the conductor caulking portions 16 and the upper surface of the bottom portion 14 corresponding thereto. In the first embodiment, three serrations 15 are formed side by side at intervals in the extending direction (the left-and-right direction, in FIGS. 3A to 3C) of the electric wire 20.

The partner connecting part 11 is formed in a substantially rectangular shape having a mounting hole 13 through which, for example, bolts can be inserted, while the partner connecting part 11 can be connected to a partner terminal by bolts and nuts. Here, the shape of the partner connecting part 11 is not limited to the configuration of the present embodiment, but other shapes such as a circular shape can also be employed.

Next, description is given of the terminal connecting method according to the first embodiment.

The terminal connecting method of the first embodiment includes a conductor crimping step and a frictionally welding step.

### (Conductor Crimping Step)

Firstly, in the conductor crimping step, as shown in FIGS. 1A and 1B, the conductor 23 composed of the plurality of strands 21 is placed on the upper surface of the bottom portion 14 of the electric wire crimping part 12 of the terminal 10, and the conductor caulking portions 16 and connecting caulking portions 19 (both of which are caulking portions extended from the bottom portion 14) caulk the conductor 23 in a manner to cover the same, thereby crimping the conductor 23.

In the first embodiment, the front end of the conductor 23 exposed to the end portion of the electric wire 20 is placed on such portion of the upper surface of the bottom portion 14 as corresponds to the connecting caulking portions 19, and the vicinity of the above front end is placed on such portion of the upper surface of the bottom portion 14 as includes the serrations 15. Also, the front end of the insulating coating 24 in the end portion of the electric wire 20 is placed on such portion of the upper surface of the bottom portion 14 as corresponds to the coating caulking portions 18.

And, as shown in FIGS. 1B and 2A, the conductor caulking portions 16 and connecting caulking portions 19 are caulked in a manner to cover the conductor 23 and are crimped to the conductor 23, while the coating caulking portions 18 are caulked in a manner to cover the front end of the insulating coating 24 and are crimped to the insulating coating 24.

The serrations 15 formed in the conductor caulking portions 16, when the conductor caulking portions 16 are caulked, bite into the conductor 23, whereby they break oxide films formed on the surfaces of the strands 21 of the electric wire 20 having a relatively smaller diameter and thus can lower the electrical contact resistance.

### (Frictionally Welding Step)

Next, in the frictionally welding step, as shown in FIGS. 1C and 2B, using a friction stir tool 51, in the stir welding area A, there are formed friction stir connection portions 33 (shaded portions, in FIGS. 1C and 2B) in which the conductor 23 and the connecting caulking portions 19 (which are a portion of the terminal 10) are allowed to plastically flow integrally and are thereby adhered together.

The friction stir tool 51 of the first embodiment, as shown in FIGS. 3A and 3B, is formed in a rod shape having a rounded tip end portion and, when driven rotationally by a motor 50 with its axis as the center of rotation, it frictionally stirs the stir welding area A. The axial length dimension of the friction stir tool 51 is set larger than the height from the upper surface of the bottom portion 14 to the upper end of the connecting caulking portion 19 after caulked. Also, the diameter of the friction stir tool 51 is appropriately set according to the shape, size and the like of the stir welding area A to be frictionally stirred.

Also, referring to the friction stir tool 51, for example, by mounting it on a motor 50 capable of moving in the X-, Y- and Z-axis directions (in the fore-and-rear, left-and-right and up-and-down directions), or by using it together with a vertically movable motor 50 and a horizontally movable work table, or by mounting it on a motor 50 fixed to the tip end of a multi-axis robot arm, the friction stir tool 51 is preferably capable of moving relatively to the stir welding area A of the conductor 23 crimped to the terminal 10 in the X-, Y- and Z-axis directions.

In a specific frictionally welding procedure, firstly, as shown in FIG. 3A, the terminal 10 crimped to the end portion of the electric wire 20 is fixed onto a work table 60. And, the friction stir tool 51 mounted on the motor 50 capable of moving in the X-, Y- and Z-axis directions is lowered toward the stir welding area A of the terminal 10 from above while it is being rotated by the motor 50.

And, as shown in FIG. 3B, by pressing the rotating friction stir tool 51 against the stir welding area A of the terminal 10, the friction tool 51 is caused to penetrate through the connecting caulking portion 19 in the stir welding area A and to bite into the stir welding area A until its tip end reaches the vicinity of the bottom portion 14. When the rotating friction stir tool 51 bites into the stir welding area A where the conductor 23 has been caulked by the connecting caulking portion 19, the connecting caulking portion 19 and conductor 23 in this portion are softened due to friction heat generated by the friction-rotation welding action of the friction stir tool 51 and are allowed to flow plastically.

After a certain period of time, the friction stir tool 51 bitten into the stir welding area A is lifted and is removed from the stir welding area A. Thus, as shown in FIG. 3C, in the stir welding area A, the plastically-flowing connecting caulking portion 19 and conductor 23, after removal of the friction stir tool 51, are rapidly cooled and solidified due to heat conduction, thereby forming the friction stir connection portion 33.

The above friction stir operation of the friction stir tool 51 is carried out in each of the pair of connecting caulking portions 19. Accordingly, as shown in FIGS. 1C and 2B, in the terminal 10, a pair of friction stir connection portions 33 are formed in the stir welding area A. This produces the terminal connecting structure shown in FIGS. 1A to 1C in which the friction stir connection portions 33 are formed in the stir welding area A.

Here, in the frictionally welding step, a pair of friction stir connection portions 33 may also be formed simultaneously in the stir welding area A of the terminal 10 by a pair of friction stir tools 51.

Also, after the friction stir connection portions 33 are formed in the friction welding step, the periphery of the conductor 23 crimped to the electric wire crimping part 12 is preferably sealed with a sealant. Covering of the exposed portion of the conductor 23 with the sealant can prevent water from entering the terminal 10 from outside and coming into contact with the conductor exposed portion. This can suppress occurrence of galvanic corrosion in the aluminum- or aluminum alloy-made conductor 23 crimped to the copper- or copper alloy-made terminal 10.

Next, description is given of the operation of the terminal connecting method and terminal according to the first embodiment.

According to the terminal connecting method and terminal of the first embodiment, in the stir welding area A of the terminal 10, a portion of the terminal 10 and the plurality of strands 21 are allowed to flow plastically by the friction stir tool 51 and thus are frictionally stirred and connected together. Due to this, films such as oxide films formed on the surfaces of the strands 21 of the conductor 23 are broken and thus the strands 21 are allowed to be connected together, and the thus-connected strands are integrated with the terminal 10, thereby enhancing the electrical connection reliability. Also, since they are frictionally stirred and connected together in the stir welding area A which is a crimping portion formed by the connecting caulking portion 19 different from the conductor caulking portion 16, the fixing force of the conductor caulking portion 16 to the conductor 23 cannot be lowered. That is, since the conductor 23 is mechanically connected in the conductor caulking portion 16 and the conductor 23 is mechanically and electrically in the stir welding area A, the conductor 23 can be connected to the terminal 10 stably. Thus, when a portion of the terminal 10 and the plurality of strands 21 are frictionally stirred and connected together in the stir welding area A, an adverse effect on the conductor caulking portion 16 can be eliminated. Accordingly, the electrical contact resistance can be reduced without lowering the fixing force of the terminal 10 to the conductor 23.

Also, since a portion of the terminal 10 and the plurality of strands 21 of the conductor 23 are frictionally stirred and connected together in the stir welding area A by the friction stir tool 51 having a simple configuration capable of rotation, expensive ultrasonic equipment is not required and thus the manufacturing cost can be reduced.

Also, according to the terminal connecting method and terminal of the first embodiment, since the electric wire 20 composed of an aluminum electric wire and terminal 10 are crimped to each other, strong oxide films exist on the surfaces of the strands 21 made of aluminum or aluminum alloy, which can provide an inhibitory factor in reducing the electrical resistance. However, since the oxide films formed on the surfaces of the strands 21 are broken by the frictionally welding operation, the terminal 10 and electric wire 20 can be connected together with small electrical connection resistance.

Here, in the first embodiment, in the frictionally welding step, after the friction stir tool 51 is lowered and bitten into the stir welding area A to allow the connecting caulking portions 19 and conductor 23 to flow plastically, the friction stir tool 51 is removed. However, alternatively, the friction stir tool 51 may also be removed after execution of a moving stir operation by the friction stir tool 51 in which the friction stir tool 51 bitten into the stir welding area A is moved in a direction along the bottom portion 14, namely, in the horizontal direction to allow the connecting caulking portions 19 and conductor 23 to flow plastically further.

Next, description is given of various examples of movements in the moving stir operation in which the friction stir tool 51 is moved in a direction along the bottom portion 14, namely, in the horizontal direction to frictionally stir the connecting caulking portions 19 and conductor 23.

### Movement Example 1

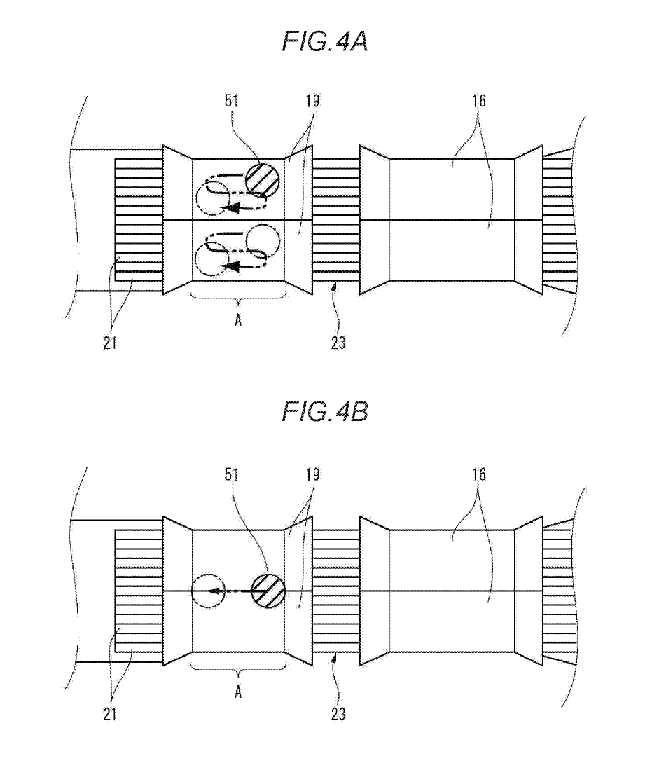

As shown in FIG. 4A, in the movement example 1, in the respective connecting caulking portions 19 in the stir welding area A, the friction stir tool 51 is bitten therein and is moved in the front-and-rear direction. Here, in the movement example 1, at a transformation point of the movement in the front-and-rear direction, the friction stir tool 51 is slightly displaced in the width direction.

### Movement Example 2

As shown in FIG. 4B, in the movement example 2, the friction stir tool 51 is bitten into the rear side of the abutting portion of the connecting caulking portions 19 in the stir welding area A and is then moved forward. Here, in the movement example 2, the friction stir tool 51 may be bitten into the front side of the abutting portion of the connecting caulking portions 19 in the stir welding area A and may be then moved rearward.

### Movement Example 3

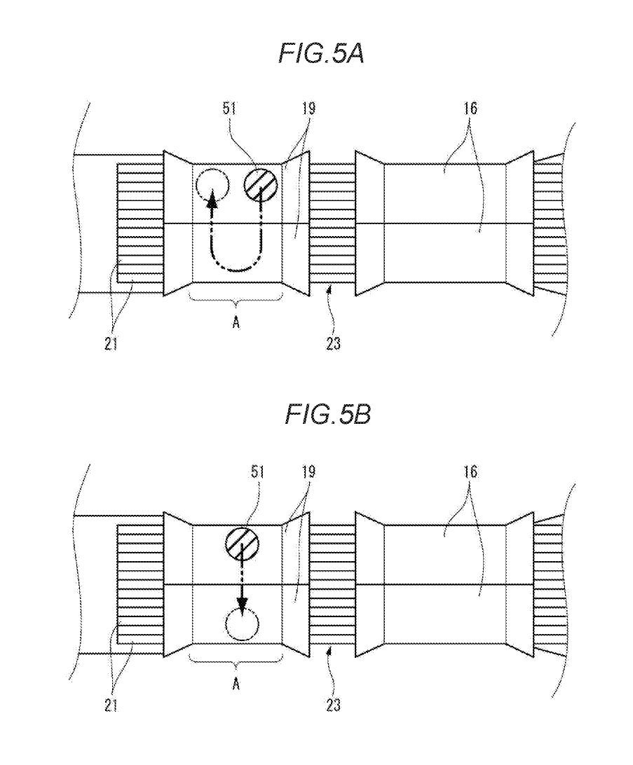

As shown in FIG. 5A, in the movement example 3, the friction stir tool 51 is bitten into the rear side of one of the connecting caulking portions 19 in the stir welding area A and is moved in the width direction toward the other connecting caulking portion 19; and, after then, the friction stir tool 51 is displaced forward and is then moved in the width direction toward one of the connecting caulking portions 19. Here, in the movement example 3, alternatively, the friction stir tool 51 may be bitten into the front side of one of the connecting caulking portions 19 in the stir welding area A and may be then moved in the width direction toward the other connecting caulking portion 19; and, after then, the friction stir tool 51 may be displaced rearward and may be then moved in the width direction toward one of the connecting caulking portions 19.

### Movement Example 4

As shown in FIG. 5B, in the movement example 4, the friction stir tool 51 is bitten into the substantially central portion in the front-and-rear direction of one of the connecting caulking portions 19 in the stir welding area A, and is then moved in the width direction toward the other connecting caulking portion 19.

In this manner, in the frictionally welding step, after friction stir tool 51 is lowered and is bitten into the stir welding area A, by executing the moving stir operation in which the friction stir tool 51 is moved in a direction along the bottom portion 14, that is, in the horizontal direction, the connecting caulking portions 19 and conductor 23 are allowed to flow plastically in a wide range in the stir welding area A to thereby form the friction stir connection portions 33. This can further enhance the electrical connection reliability in the stir welding area A.

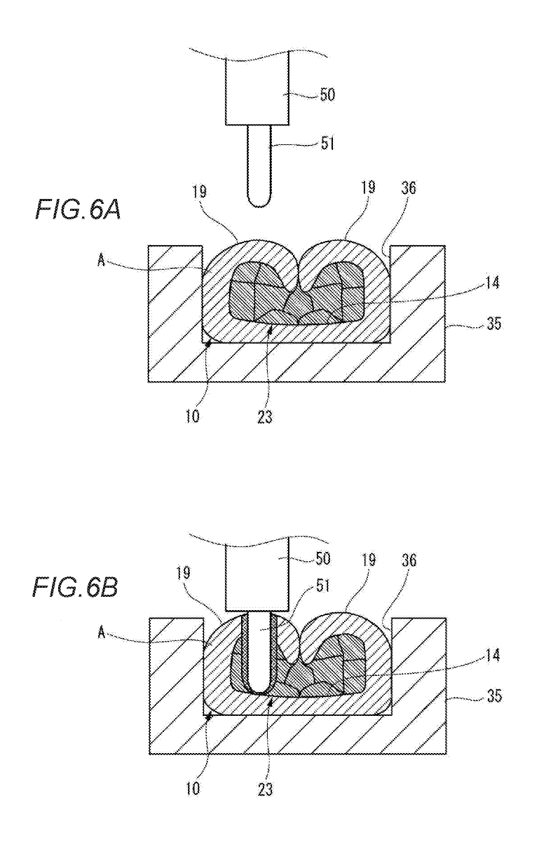

Here, when executing the above moving stir operation, with the movement of the friction stir tool 51, a laterally going large load is applied to the terminal 10. Thus, as shown in FIG. 6A, when executing the frictionally welding step including a moving stir operation, a jig 35 is used. The jig 35 includes a holding recessed portion 36 for holding the terminal 10 fitted therein. When executing the frictionally welding step using the jig 35, the terminal 10 crimped to the end portion of the electric wire 20 is fitted into the holding recessed portion 36 of the jig 35 fixed to a work table 60 with the bottom portion 14 thereof directed downward. Thus, the terminal 10 is kept in a state where it is held by the jig 35. In this state, as shown in FIG. 6B, the friction stir tool 51 is bitten into the stir welding area A of the terminal 10 and the friction stir tool 51 is then moved in a direction along the bottom portion 14 (which is the horizontal direction); and, after execution of the moving stir operation to allow the connecting caulking portions 19 and conductor 23 to flow plastically, the friction stir tool 51 is removed. And, with use of the jig 35, when moving the friction stir tool 51 bitten into the stir welding area A, the terminal 10 can be positively held, thereby allowing the friction stir tool 51 to positively execute a moving stir operation on the stir welding area A of the terminal 10.

In this way, when the stir welding area A of the terminal 10 is frictionally stirred by the friction stir tool 51, by fixing the terminal 10 using the jig 35, the friction stir operation can be performed stably and smoothly. Also, the deformation of the terminal 10 and the opening of the connecting caulking portions 19 due to execution of the friction stir operation can be suppressed.

Here, in the first embodiment, the friction stir tool 51 is bitten into the stir welding area A from the connecting caulking portion 19 side to stir the area frictionally. However, the friction stir tool 51 may also be bitten into the stir welding area A from the bottom portion 14 side.

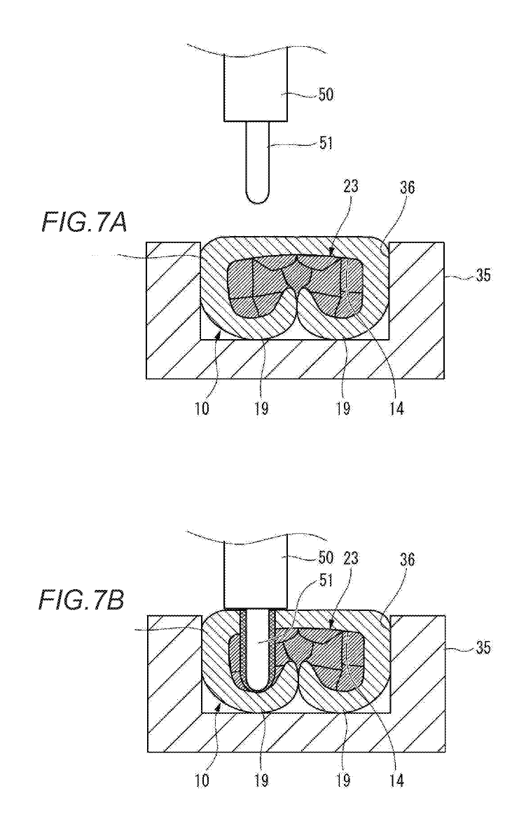

Specifically, as shown in FIG. 7A, the terminal 10 crimped to the end portion of the electric wire 20 is arranged with the bottom portion 14 facing upward, and, as shown in FIG. 7B, the rotating friction stir tool 51 is pressed against the stir welding area A of the terminal 10 and is bitten therein until the tip end thereof penetrates through the bottom portion 14 in the stir welding area A and reaches the vicinity of the connecting caulking portion 19, thereby allowing the friction stir tool 51 to frictionally stir the stir welding area A.

In this case as well, when performing the frictionally welding step including the moving stir operation, as shown in FIGS. 7A and 7B, the terminal 10 with the bottom portion 14 facing upward is fitted into and held by the holding recessed portion 36 of the jig 35 fixed to the work table 60.

Here, even when performing a frictionally welding step excluding the moving stir operation, the terminal 10 may be fitted into and held by the holding recessed portion 36 of the jig 35. In this way, by allowing the jig 35 to hold the terminal 10, the posture of the terminal 10 when the friction stir tool 51 is bitten therein can be stabilized, and thus the frictionally welding step can be performed smoothly.

### Second Embodiment

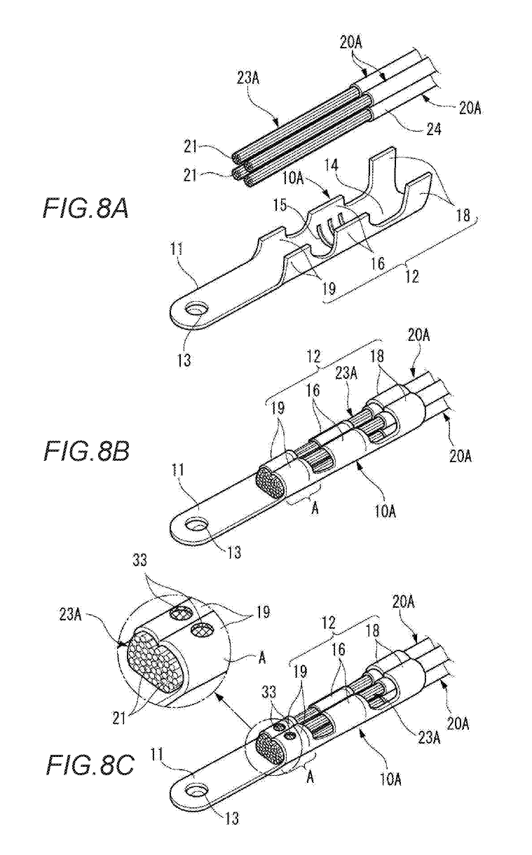

FIGS. 8A to 8C are perspective views for explaining the steps of a terminal connecting method according to a second embodiment of the invention.

As shown in FIGS. 8A to 8C, the terminal connecting method according to the second embodiment of the invention is a terminal connecting method which joint connects the plurality of (in the present embodiment, four) electric wires 20A to a terminal 10A. Here, similar configurations to the terminal 10 and electric wire 20 of the first embodiment are given the same designations and the specific description thereof is omitted.

In each of the electric wires 20A, as shown in FIG. 8A, a conductor 23A is formed by bundling together the plurality of strands 21 in such a manner that its diameter is smaller than that of the conductor 23 of the electric wire 20 of the first embodiment. In the end portion of each electric wire 20A, an insulating coating 24 is peeled off to thereby expose the conductor 23A. The conductor caulking portions 16 and connecting caulking portions 19 of the terminal 10A are connected to the bundles of the core wires of the four exposed conductors 23A. In the terminal 10A as well, a portion where the conductors 23A are caulked by the connecting caulking portions 19 is defined as a stir welding area A. In this stir welding area A, there are formed friction stir connection portions 33 which are formed by allowing the conductors 23A and connecting caulking portions 19 to flow plastically.

Here, in the four electric wires 20A, the conductors 23A may be composed of only aluminum electric wires made of aluminum or aluminum alloy, or the conductors 23A may be composed of a combination of copper electric wires made of copper or copper alloy and aluminum electric wires.

The terminal 10A, similarly to the terminal 10 of the first embodiment, is formed by molding a plate-shaped member made of copper or copper alloy by mold press working or the like, and includes a partner connecting part 11 and an electric wire crimping part 12 formed integrally with the partner connecting part 11.

Next, description is given of the terminal connecting method of the second embodiment.

### (Conductor Crimping Step)

Firstly, in the conductor crimping step, as shown in FIGS. 8A and 8B, the bundles of core wires composed of four conductors 23A are placed on the upper surface of the bottom portion 14 of the electric wire crimping part 12 of the terminal 10A, and the conductor caulking portions 16 and connecting caulking portions 19 extended from the bottom portion 14 caulk the bundles of core wires composed of four conductors 23A in a manner to cover the same, thereby crimping the conductors 23A.

In the second embodiment, the front ends of the bundles of core wires composed of the conductors 23A exposed to the terminal portions of the electric wires 20A are placed on the upper surface of the bottom portion 14 corresponding to the connecting caulking portions 19, and the vicinities of the front ends are placed on the upper surface of the bottom portion 14 where the serrations 15 formed. And, the front ends of the insulating coatings 24 in the end portions of the electric wires 20A are placed on the upper surface of the bottom portion 14 corresponding to the coating caulking portions 18. And, the conductor caulking portions 16 and connecting caulking portions 19 are caulked in a manner to cover the bundles of the core wires composed of the four conductors 23A and are crimped to the conductors 23A, and the coating caulking portions 18 are caulked in a manner to cover the front ends of the insulating coatings 24 and are crimped to the insulating coatings 24.

Since the conductor caulking portions 16 of the terminal 10A are bitten into the conductors 23A when they are caulked, the serrations 15 formed in the conductor caulking portions 16 can break oxide films formed on the surfaces of the strands 21 of the four joint-connected electric wires 20A, thereby lowering the electrical contact resistance.

### (Frictionally Welding Step)

Next, in the frictionally welding step, similarly to the terminal connecting method of the first embodiment, using the friction stir tool 51, as shown in FIG. 8C, in the stir welding area A including the connecting caulking portions 19, there are formed friction stir connection portions 33 (shaded portions, in FIG. 8C) where the conductors 23A and connecting caulking portions 19 integrally flow plastically and are thereby adhered together.

Here, in the second embodiment as well, in the frictionally welding step, there may be performed a moving stir operation in which the friction stir tool 51 bitten into the stir welding area A is moved in a direction along the bottom portion 14 (which is the horizontal direction). When performing the frictionally welding step including this moving stir operation, the terminal 10A is fitted into and held by the holding recessed portion 36 of the jig 35 fixed to the work table 60 (see FIGS. 6A and 6B.).

Also, in the second embodiment as well, the friction stir tool 51 may be bitten into the terminal 10A held with the bottom portion 14 facing upward from the bottom portion 14 side in the stir welding area A to frictionally stir the strands and terminal (see FIGS. 7A and 7B.).

Next, description is given of the operations of the terminal connecting method and terminal according to the second embodiment.

According to the terminal connecting method and terminal of the second embodiment, in addition to operation effects similar to the terminal connecting method and terminal according to the first embodiment, by frictionally welding the strands 21 in the bundles of the core wires exposed to the terminal portions of the plurality of electric wires 20A and a portion of the terminal 10A, there is provided an operation effect that the plurality of electric wires 20A can be connected to the terminal 10A stably and easily.

Therefore, according to the terminal connecting method and terminal of the above embodiments, the electrical contact resistance with the conductors 23, 23A can be lowered without reducing the fixing force to the conductors 23, 23A.

The invention is not limited to the above embodiments but mutual combinations of the respective configurations of the embodiments, and changes and applications made by a person skilled in the art based on the description of the specification and well-known technology are also included within the scope of seeking protection of the invention.

Here, the characteristics of the embodiments of the terminal connecting method and terminal according to the above-mentioned invention are briefly summarized and are listed in the following configurations [1] to [6].

[1] A terminal connecting method comprising:

setting a conductor (23, 23A) having a plurality of strands (21) on an upper surface of a bottom portion (14) of an electric wire crimping part (12) of a terminal (10, 10A);

caulking the conductor (23, 23A) in a manner to cover the conductor (23, 23A), and thereby crimping the conductor (23, 23A) by a caulking portion (16) and a connecting caulking portion (19) extended from the bottom portion (14); and

rotating and pressing a friction stir tool (51) into a stir welding area (A) in a part in which the conductor (23, 23A) is crimped by the connecting caulking portion (19), and performing friction stir welding, after caulking and crimping.

[2] The terminal connecting method according to the above configuration [1],

wherein, in the performing friction stir welding, a moving stir operation in which the friction stir tool (51) is moved along the bottom portion (14) is performed, after rotating and pressing the friction stir tool (51) into the stir welding area (A).

[3] The terminal connecting method according to the above configuration [1] or [2],

wherein, in the performing friction stir welding, the terminal (10) is fitted into and held by a holding recessed portion (36) formed in a jig (35).

[4] The terminal connecting method according to any one of the above configurations [1] to [3],

wherein the conductor (23A) is a bundle of the plurality of strands (21) exposed in one end portions of a plurality of electric wires (20A) in which insulating coating (24) are peeled off respectively.

[5] The terminal connecting method according to any one of the above configurations [1] to [4],

wherein the plurality of strands (21) are made of aluminum or aluminum alloy.

[6] A terminal comprising:

a bottom portion (14) on which a conductor (23, 23A) having a plurality of strands (21) is set; and

a conductor caulking portion (16) and a connecting caulking portion (19) extended from the bottom portion (14) and respectively caulked in a manner to cover the conductor (23, 23A) so as to crimp the conductor (23, 23A),

wherein the conductor caulking portion (16) in which the conductor (23, 23A) is crimped, includes a stir welding area (A) into which a friction stir tool (51) is rotated and pressed and in which friction stir welding is performed.

### DESCRIPTION OF REFERENCE NUMERALS AND SIGNS

10: Terminal
14: Bottom portion
16: Conductor caulking portion
19: Connecting caulking portion
20, 20A: Electric wire
21: Elementary wire
23, 23A: Conductor
24: Insulating coating
35: Jig
36: Holding recessed portion
51: Friction stir tool
A: Stir welding area

What is claimed is:

1. A terminal connecting method comprising:
setting a conductor having a plurality of strands on an upper surface of a bottom portion of an electric wire crimping part of a terminal;
caulking the conductor in a manner to cover the conductor, and thereby crimping the conductor by a caulking portion and a connecting caulking portion extended from the bottom portion; and
rotating and pressing a friction stir tool into a stir welding area in a part in which the conductor is crimped by the connecting caulking portion, and performing friction stir welding, after caulking and crimping.

2. The terminal connecting method according to claim 1,
wherein, in the performing friction stir welding, a moving stir operation in which the friction stir tool is moved along the bottom portion is performed, after rotating and pressing the friction stir tool into the stir welding area.

3. The terminal connecting method according to claim 1,
wherein, in the performing friction stir welding, the terminal is fitted into and held by a holding recessed portion formed in a jig.

4. The terminal connecting method according to claim 1,
wherein the conductor is a bundle of the plurality of strands exposed in one end portions of a plurality of electric wires in which insulating coating are peeled off respectively.

5. The terminal connecting method according to claim 1,
wherein the plurality of strands are made of aluminum or aluminum alloy.

6. A terminal comprising:
a bottom portion on which a conductor having a plurality of strands is set; and
a conductor caulking portion and a connecting caulking portion extended from the bottom portion and respectively caulked in a manner to cover the conductor so as to crimp the conductor,
wherein the conductor caulking portion in which the conductor is crimped, includes a stir welding area into which a friction stir tool is rotated and pressed and in which friction stir welding is performed.
